(19) United States
(12) Patent Application Publication
(10) Pub. No.: US 2026/0349231 A1
(43) Pub. Date: Nov. 5, 2026

(54) MIRROR LENS, OPTICAL RESONATOR DEVICE, AND METHOD FOR OPTICAL ABSORPTION MEASUREMENT

(71) Applicant: August DORN, Hannover (DE)

(72) Inventor: August DORN, Hannover (DE)

(21) Appl. No.: 19/713,493

(22) Filed: Jun. 18, 2026

Related U.S. Application Data
(63) Continuation of application No. PCT/EP2024/086733, filed on Dec. 17, 2024.

(30) Foreign Application Priority Data
Dec. 19, 2023 (DE) 10 2023 135 713.1

(51) Int. Cl. G02B 17/00; G01N 21/25; G02B 26/08

(52) U.S. Cl. CPC G02B 17/004; G01N 21/255; G02B 26/0816

(57) ABSTRACT

A mirror lens is provided that enables ultrasensitive spectrally resolved absorption measurements in the nanoscale range and efficient focusing of a light field inside an optical cavity without adversely affecting the finesse of the optical cavity. The mirror lens includes a housing with a light passage opening, wherein a reflective and/or refractive optical element is arranged in the housing, wherein the mirror lens comprises a dielectric back reflector, or a curved dielectric mirror that is arranged in the light passage opening.

### CROSS-REFERENCE TO RELATED APPLICATIONS

This application is a continuation of International Application No. PCT/EP2024/086733, filed on Dec. 17, 2024, which claims priority to and the benefit of DE 10 2023 135 713.1, filed on Dec. 19, 2023. The disclosures of the above applications are incorporated herein by reference.

### FIELD

The present disclosure relates to a mirror lens comprising a housing with a light passage opening, wherein a reflective and/or refractive optical element is arranged within the housing.

Furthermore, the present disclosure relates to an optical resonator device comprising a mirror lens, as well as a method for optical absorption measurement of samples with a small absorption cross-section using an optical resonator device.

### BACKGROUND

The statements in this section merely provide background information related to the present disclosure and may not constitute prior art.

Fluorescence spectroscopy of individual quantum emitters such as molecules, color centers, or nanocrystals is a well-established field of research. The ability to study the fluorescence of individual quantum emitters has provided deep insights into the photophysics of these structures and enabled new imaging techniques in the life sciences.

However, comparable techniques for measuring the absorption spectra of nanoscale quantum structures are not known. Absorption spectra contain a wealth of information that is not accessible through fluorescence. For example, fluorescence spectra are typically dominated by a few or even a single state. Absorption spectra, on the other hand, can map the spectrum and the density of the states of a sample in a broad energy window. It is not uncommon for samples to have similar or even indistinguishable fluorescence spectra but to exhibit distinct differences in absorption. Methods for measuring absorption spectra at the microscopic level are therefore of great interest in many areas of nanotechnology and the life sciences.

In fluorescence spectroscopy, samples are typically excited with short-wavelength light, and the subsequently emitted longer-wavelength fluorescence is detected and analyzed by a fluorescence detector. The fluorescence detector can be shielded from the excitation light by optical filters or by temporal separation of sample excitation and fluorescence light detection, e.g., through the use of pulsed lasers and time-resolved detection. In both cases, the fluorescence signal is detected against a “dark” background. In contrast, absorption spectroscopy measures the extinction of an incident light signal. The very small absorption cross-sections of individual nanostructures result in most of the incident photons passing through without interacting with the nanostructure. The resulting, very weak extinction signal is consequently masked by a very strong background of directly transmitted light. This intense background is inevitably associated with strong photon noise, which typically superimposes the absorption features of interest. Additional noise can be caused by mechanical instabilities in the setup, intensity fluctuations of the excitation light source, and dark counts of the detector.

Some of these obstacles can be mitigated by rapidly moving the sample in and out of the focused light beam of the probe. This allows for a direct and rapid comparison between the background signal and the absorption features of the sample. However, this technique is only of limited use, as it does not eliminate the strong photon noise of the directly transmitted light.

A microscopy measurement system is disclosed in US2017/0261739A1. The measurement system comprises a focused light source, a first mirror, a plurality of first lenses, a second mirror, a plurality of second lenses, and an imaging device. The first mirror is positioned on a first side of a sample and configured to receive light from the light source. The plurality of first lenses is arranged between the first mirror and the sample. The second mirror is located on a second side of the sample. The several second lenses are located between the second mirror and the sample. The imaging device is arranged adjacent to the second mirror and configured to receive light from the light source after the light has undergone a plurality of reflections between the first mirror and the second mirror and through the first lenses and second lenses.

From DE102012106867B4, a confocal light microscope with or without a pinhole aperture for performing optical absorption measurements on a sample with a small absorption cross-section is known, comprising at least one light source, wherein the light microscope has an optical resonator configured to receive the sample and illuminate it with light.

### SUMMARY

This section provides a general summary of the disclosure and is not a comprehensive disclosure of its full scope or all of its features.

One or more embodiments of the present disclosure provide devices and methods that enable ultrasensitive, spectrally resolved absorption measurements in the nanoscale range.

The present disclosure is based on the task of providing a mirror lens that enables ultrasensitive spectrally resolved absorption measurements in the nanoscale range and efficient focusing of a light field inside an optical cavity with very high finesse.

To solve the task underlying the present disclosure, a mirror lens is proposed comprising a housing with a light passage opening, wherein a reflective and/or refractive optical element is arranged in the housing, wherein it is further provided that the mirror lens comprises a dielectric back reflector, or that a curved dielectric mirror is arranged in the light passage opening.

The mirror lens comprises a housing. The housing may be substantially formed rotationally symmetric, wherein the axis of rotation or axis of symmetry of the housing may substantially correspond to the optical axis of the mirror lens.

The light passage opening is suitable to allow light to both exit the housing and enter the housing.

The mirror lens in one form is suited for use in a resonator-enhanced microscopy method or in a method for optical absorption measurement.

According to the present disclosure, the mirror lens has a dielectric back reflector. Alternatively or additionally, a curved dielectric mirror may also be arranged in the light passage opening.

Resonator-enhanced microscopy methods, but also methods for optical absorption measurement, are based on optical cavities that combine high finesse with tight focusing of the captured light. The finesse of an optical cavity is a measure of how close the optical resonances are in relation to their frequency spacing. The finesse of an optical cavity is given by

$$F / π ≅ \frac{\sqrt{R}}{( 1 - R )} ≅ 1 / ( 1 - R )$$

for R close to 1, wherein R is the reflectivity of the mirrors of the optical cavity. Dielectric mirrors have a high reflectivity of preferably over 99%, more preferably over 99.9%. Due to the dielectric back reflector or the curved dielectric mirror arranged in the light passage opening, a mirror lens can thus be provided that can be used in optical cavities with a very high finesse.

In one or more embodiments it is provided that the optical system comprises a primary concave mirror and a secondary convex mirror, wherein the primary mirror has a central aperture, and wherein the primary mirror and the secondary mirror are dielectric mirrors.

The primary mirror has a central aperture, which means, in particular, that the primary mirror has a hole or opening in the center through which light can pass.

Furthermore it can be provided that the optical system comprises at least one lens, in particular a converging lens.

In resonator-enhanced microscopy methods based on optical cavities and in methods for optical absorption measurement, small focal spot diameters are desirable to achieve maximum interaction between a sample and the light field. Focal spot diameters are a function of the wavelength λ of the incident light and the numerical aperture (NA) of the focusing optics. High numerical apertures enable focusing on focal spots with smaller diameters. High numerical apertures therefore also enable better resolution, particularly in the lateral xy plane of an image. The full width at half maximum (FWHM) of the point spread function in a confocal microscope can be estimated as FWHM=0.51λ/NA. To achieve high numerical apertures, focusing optics can be used. However, additional focusing optics can cause additional losses due to scattering, reflection, and absorption. This can have a detrimental effect on the overall finesse of an optical cavity.

By configuring the mirror lens with a primary concave mirror and a secondary convex mirror, as well as a dielectric back reflector or a dielectric mirror arranged in the light passage opening, achromatic focusing over a wide spectral range is enabled. The mirror lens can be provided with dielectric mirrors that can be used for light in the range from the far infrared to the far UV. The dielectric mirrors can reflect in narrowband or broadband wavelength ranges.

When the mirror lens is used in an optical resonator device, the dielectric back reflector, as explained below, can form an optical cavity together with another resonator mirror. The mirror lens is then, in a sense, positioned between the back reflector that forms the optical cavity and the resonator mirror. Thus, the advantages of the mirror lens—namely, achromatic focusing and low light loss over a wide spectral range—can also be advantageously achieved in an optical resonator device and in methods performed therewith, such as resonator-enhanced microscopy methods or methods for optical absorption measurement.

If a curved dielectric mirror is located in the light passage opening of the mirror lens, then when the mirror lens is used in an optical resonator device, the optical cavity can be formed between the curved dielectric mirror arranged in the light passage opening and the resonator mirror. In this case, the mirror lens with the reflective and/or refractive optics is located outside the optical cavity, so that the mirror lens has no influence on the finesse of the optical cavity. In this case, therefore, the optics may be refractive optics and comprise in particular a lens, more specifically a converging lens. However, even in this case, it is possible for the optics to comprise a primary concave mirror and a secondary convex mirror.

The mirror lens has low light losses and is therefore suitable for integration into optical cavities with very high finesse.

In one or more embodiments it is provided that the secondary mirror is arranged and configured to reflect light entering through the aperture onto the primary mirror and/or to reflect light reflected by the primary mirror out through the aperture.

Furthermore, it may be provided that the back reflector is arranged and configured to reflect light exiting through the aperture back through the aperture.

The back reflector in one form is arranged on a side of the housing opposite the light passage opening. In this case, the back reflector may be arranged and/or attached directly to the housing of the mirror lens, but it is also possible for the back reflector to be arranged at a distance from the housing. A spaced arrangement is particularly advantageous when the mirror lens is integrated into a microscopy setup.

In one or more embodiments it is provided that the primary mirror is a spherical or aspherical mirror, and/or that the secondary mirror is a spherical or aspherical mirror.

In principle, the primary mirror and the secondary mirror may be spherical mirrors. Furthermore, it may be provided that the primary mirror and the secondary mirror are aspherical mirrors. Combinations are also possible, such that, for example, the primary mirror is a spherical mirror and the secondary mirror is an aspherical mirror. In particular, the primary mirror and/or the secondary mirror may also be hyperbolic mirrors or parabolic mirrors.

In one or more embodiments it is provided that the primary mirror and the secondary mirror have a common center of curvature.

In this case, it is particularly advantageous if the primary mirror and the secondary mirror are spherical mirrors. In this case, the mirror lens may be formed similar to a Schwarzschild lens.

Furthermore, it may be provided that the mirror lens is an infinity-corrected mirror lens.

However, it is also possible for the mirror lens to be a finitely corrected mirror lens.

As a further advantage, it is provided that the primary mirror and the secondary mirror and/or the back reflector and/or the light passage opening and/or the curved mirror are arranged concentrically.

It may further be provided that the secondary mirror is arranged between the primary mirror and the light passage opening, wherein in one form the primary mirror is arranged between the secondary mirror and the back reflector.

The relative arrangement of the primary and secondary mirrors or the back reflector is to be understood with respect to the axis of symmetry or optical axis of the mirror lens. Thus, starting from a first end of the mirror lens, the back reflector may be provided first. Subsequently, the secondary mirror, the primary mirror, and finally the light passage opening are arranged. In principle, however, it is also possible for the back reflector to be arranged at a first end of the housing, followed by the secondary mirror and then the primary mirror. The light passage opening of the housing is then located behind the primary mirror.

In addition, it may be provided that the lens and/or the back reflector and/or the light passage opening and/or the curved mirror are arranged concentrically.

As a further advantage, the back reflector may be a curved, in particular concave, mirror.

Furthermore, it may be provided that the mirror lens further comprises actuators, wherein a position of the back reflector or the curved mirror can be varied by means of the actuators.

If the mirror lens comprises a back reflector, the optical cavity of an optical resonator device equipped with the mirror lens can be stabilized at a specific resonance wavelength by operating the actuators, wherein the position of the back reflector and thus the length of the optical cavity is precisely adjusted and actively controlled.

If the mirror lens has a curved mirror in the light passage opening, its position can be varied by operating the actuators, and thus the length of the optical cavity can be precisely adjusted and the resonance frequency of the optical cavity can be stabilized.

In particular, in applications such as resonator-enhanced microscopy or optical absorption measurement methods, varying the position of the back reflector and/or the curved mirror in the light passage opening also makes it possible to scan samples at least two-dimensionally in the xy plane, and optionally also three-dimensionally in the xyz direction. In particular, the focal point of the mirror lens can be scanned in the xyz direction by varying the position of the back reflector and/or the curved mirror.

In one or more embodiments the actuators are piezo actuators.

A further solution to the task underlying the present disclosure consists of an optical resonator device, particularly suitable for performing optical absorption measurements, wherein the optical resonator device comprises a mirror lens as described above.

In one or more embodiments, the optical resonator device comprises a flat, resonator mirror, and the optical resonator device comprises an optical cavity, wherein the optical cavity is formed between the resonator mirror and the back reflector or between the resonator mirror and the curved mirror.

In the case where the optical cavity is formed between the resonator mirror and the curved mirror, the reflective and/or refractive optics of the mirror lens are located outside the optical cavity and thus have no influence on the finesse of the optical cavity.

Furthermore, it may be provided that the optical resonator device comprises a substrate, wherein the substrate comprises the resonator mirror and at least one spacer layer, wherein the at least one spacer layer is arranged on the resonator mirror, in particular on an upper surface of the resonator mirror, wherein a sample may be arranged on the spacer layer.

In one or more embodiments, the substrate has two spacer layers.

The at least one spacer layer in one or more embodiments is located within the optical cavity formed by the resonator mirror and the back reflector or the curved mirror.

By means of the spacer layer it can be provided that a sample to be tested is positioned at an antinode of the light field reflected by the resonator mirror, at an optical distance of λ/4 from the surface of the resonator mirror.

As a further advantage, it may be provided that the optical resonator device may comprise actuators, wherein a position of the resonator mirror can be varied by means of the actuators, wherein the actuators in one form are piezo actuators.

Analogous to the actuators of the mirror lens, the resonator mirror can be positioned by means of the actuators, in particular the piezo actuators, of the optical resonator device, and thus the length of the optical cavity can be adjusted.

Here, actuators may be provided exclusively on the resonator mirror. In principle, however, it is also conceivable that both the mirror lens and the resonator mirror have actuators.

Furthermore, it may be provided that the substrate comprises, in one form plasmonic or dielectric, nanostructures and/or biofunctionalization structures, wherein the nanostructures and/or biofunctionalization structures are in one form provided in or on the at least one spacer layer.

By configuring the substrate with plasmonic or dielectric nanostructures, additional signal amplification can be achieved through additional light confinement and/or a surface-enhanced Raman scattering effect. This additional signal amplification can be useful for applications in biosensor technology for the detection of DNA, viruses, bacteria, cells, antibodies, or other substances. The substrate may be recessed, protruding, or flat at the locations where the plasmonic or dielectric nanostructures are situated.

A further solution to the task underlying the present disclosure lies in providing a method for measuring optical absorption in samples with a small absorption cross-section, wherein it is provided that a sample is arranged in a previously described optical resonator device.

Particularly in one form, the sample is arranged on a substrate within an optical cavity of the optical resonator device.

As a further advantage, it may be provided that the sample is irradiated with light.

Further areas of applicability will become apparent from the description provided herein. It should be understood that the description and specific examples are intended for purposes of illustration only and are not intended to limit the scope of the present disclosure.

### DRAWINGS

Various embodiments of the present disclosure are explained in more detail below with reference to the accompanying figures. They show:

FIG. 1 is a first variant of a first embodiment of a mirror lens;

FIG. 2 is a second variant of the first embodiment of a mirror lens;

FIG. 3 is a third variant of the first embodiment of a mirror lens;

FIG. 4 is a fourth variant of the first embodiment of a mirror lens;

FIG. 5 is a first variant of a second embodiment of a mirror lens;

FIG. 6 is a second variant of the second embodiment of a mirror lens;

FIG. 7 is a third variant of the second embodiment of a mirror lens;

FIG. 8 is a fourth variant of the second embodiment of a mirror lens;

FIG. 9 is a third embodiment of a mirror lens;

FIG. 10a is a cross-sectional view of a substrate; and

FIG. 10b is a top view of the substrate.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

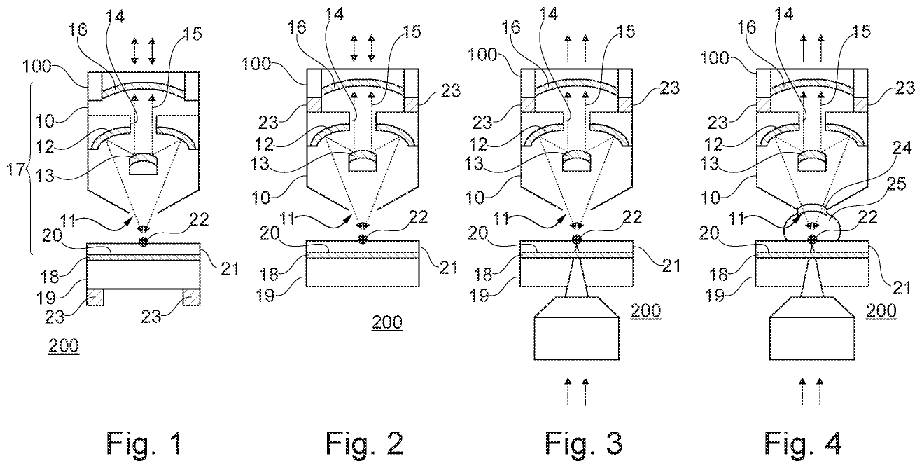

FIGS. 1 through 9 schematically illustrate various embodiments of a mirror lens 100 in an optical resonator device 200, which is suitable for performing optical absorption measurement methods or resonator-enhanced microscopy methods.

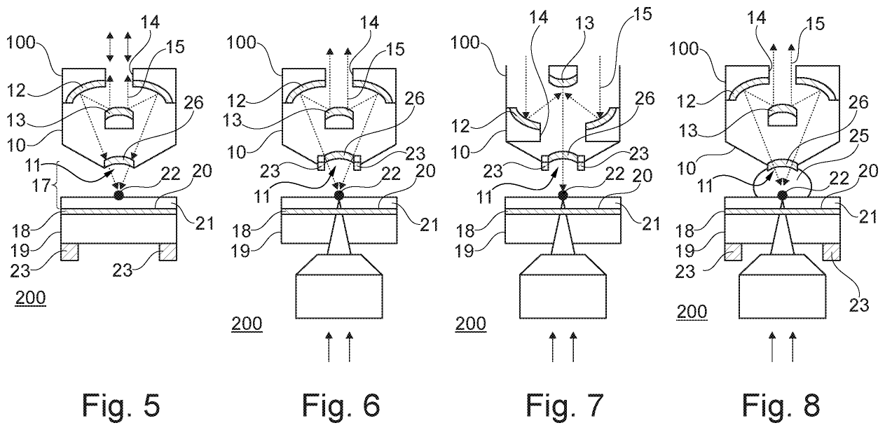

FIGS. 1 through 4 relate to variants of a first embodiment of the mirror lens 100 and the optical resonator device 200, respectively, and FIGS. 5 through 8 relate to variants of a second embodiment of the mirror lens 100. In all variants of the first and second embodiments, the mirror lens 100 comprises a housing 10 with a light passage opening 11, wherein a primary concave mirror 12 and a secondary convex mirror 13 are arranged within the housing 10. The primary mirror 12 has a central aperture 14. The secondary mirror 13 is arranged such that light 15 entering through the aperture 14 is reflected onto the primary mirror 12, or light 15 reflected by the primary mirror 12 is reflected out through the aperture 14. Both the primary mirror 12 and the secondary mirror 13 are dielectric mirrors.

In the variants of the embodiments of FIGS. 1 through 4, the mirror lens 100 further comprises a dielectric back reflector 16, wherein the primary mirror 12 is positioned between the back reflector 16 and the secondary mirror 13. The secondary mirror 13 is also arranged between the first mirror 12 and the light passage opening 11. In the arrangement of the optical resonator device 200 of FIGS. 1 through 4, an optical cavity 17 is formed between the back reflector 16 and a resonator mirror 18. In the variant of FIG. 1, light 15 can be coupled into the optical cavity 17 through the back reflector 16. Due to the high reflectivity of the dielectric mirrors, particularly the back reflector 16, the resonator mirror 18, the primary mirror 12, and the secondary mirror 13, the light 15 passes through the optical cavity 17 very often, with a small amount of light 15 being decoupled at each reflection at the back reflector 16, which is then evaluated for further processing. The optical resonator device 200 comprises a substrate 19 in which the resonator mirror 18 is embedded. On an upper surface 20 of the resonator mirror 18, a spacer layer 21 is arranged, on which a sample 22 is in turn arranged. In the variant of FIG. 1, the optical resonator device 200 has piezo actuators 23, by means of which a position of the substrate 19 and thus also of the resonator mirror 18 can be adjusted. The variant of FIG. 2 differs from the variant of FIG. 1 in that the piezo actuators 23 are part of the mirror lens 100. The position of the back reflector 16 can be varied using the piezo actuators 23 of the mirror lens 100.

In the configuration of FIG. 3, unlike the variants of FIGS. 1 and 2, the light 15 is coupled into the optical cavity 17 via the resonator mirror 18. The portion of the light 15 emerging at each pass is decoupled by the back reflector 16. A further variant is shown in FIG. 4. Unlike the variant of FIG. 3, a window 24 or a pane is located in the light passage opening 11. The mirror lens 100 is immersed in oil 25 or water with the window 24. The window 24 may have an antireflective coating.

Variants of a second embodiment of the mirror lens 100 of the optical resonator device 200 are shown in FIGS. 5 through 8. The mirror lens 100 of FIGS. 5 through 8 does not comprise a back reflector 16. Instead, a concavely curved dielectric mirror 26 is arranged in the light passage opening 11. In the optical resonator device 200, the optical cavity 17 is thus formed between the curved mirror 26 in the light passage opening 11 and the resonator mirror 18. In the variant of FIG. 5, light 15 is coupled into the mirror lens 100 via the aperture 14 of the primary mirror 12 and into and out of the cavity 17 via the curved mirror 26. In FIG. 5, the position of the resonator mirror 18 is adjusted by means of piezo actuators 23. In a further variant of FIG. 6, the curved mirror 26 is mounted on piezo actuators 23 within the light passage opening 11. By means of the piezo actuators 23, the curved mirror 26 can be moved at least in the xy-plane, in one form also three-dimensionally, in order to adjust the length of the optical cavity 17. In the variant of FIG. 6, light 15 is coupled into the optical cavity 17 by the resonator mirror 18. The light 15 is decoupled by the curved mirror 26 in the light passage opening 11 and exits the mirror lens 100 through the aperture 14 of the primary mirror 12. In the configuration of FIG. 7, the order of the primary mirror 12 and the secondary mirror 13 is reversed compared to the configuration of FIG. 6. Beyond that, however, this embodiment is identical. In the embodiment of FIG. 8, the curved mirror 26 in the light passage opening 11 is immersed in oil 25 or water.

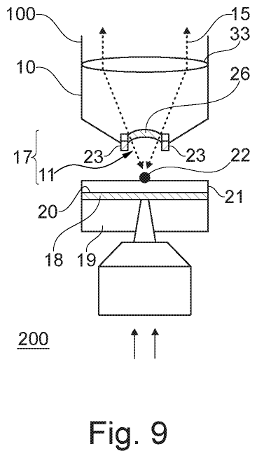

In the third embodiment of the mirror lens of FIG. 9, as in the variants of the second embodiment of FIGS. 5 through 8, a concavely curved dielectric mirror 26 is arranged in the light passage opening 11. In the optical resonator device 200, the optical cavity 17 is thus also formed between the curved mirror 26 in the light passage opening 11 and the resonator mirror 18. However, instead of a reflective optical system consisting of a primary mirror 12 and a secondary mirror 13, a converging lens 33 is arranged in the housing in the embodiment of FIG. 9. The converging lens 33 is located outside the optical cavity 17 and therefore has no influence on the finesse of the optical cavity 17. The curved mirror 26 in the light passage opening 11 is mounted on piezo actuators 23.

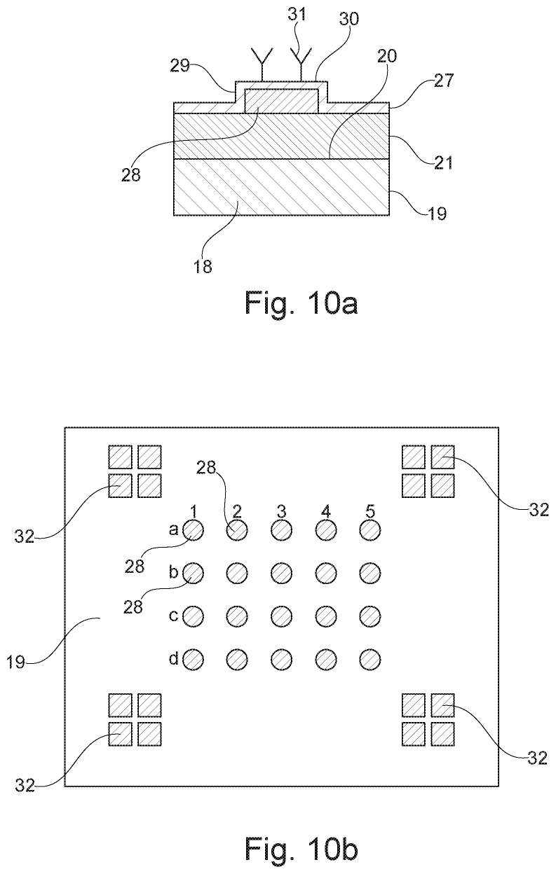

FIGS. 10a and 10c show a side view and a top view of the substrate 19 of the mirror lens 100 of FIGS. 1 through 9. The substrate 19 comprises the dielectric resonator mirror 18. Two spacer layers 21, 27 are arranged on an upper surface 20 of the resonator mirror 18. Plasmonic or dielectric nanostructures 28 are embedded in the second spacer layer 27. The nanostructures 28 are located within the second spacer layer 27, such that the substrate 19 has protrusions 29 in the region of the nanostructures 28. Biofunctionalization structures 31 are also arranged on the upper surface 30 of the second spacer layer 27. The nanostructures 28 may be arranged in a grid for proper indexing, as shown in FIG. 10b. The substrate 19 may also have markers 32 that can be used to align the substrate 19 within the optical resonator device 200.

The description of the disclosure is merely exemplary in nature and, thus, variations that do not depart from the substance of the disclosure are intended to be within the scope of the disclosure. Such variations are not to be regarded as a departure from the spirit and scope of the disclosure.

List of Reference Symbols

| | |
|---|---|
| 100 | Mirror lens |
| 200 | Optical resonator device |
| 10 | Housing |
| 11 | Light passage opening |
| 12 | Primary concave mirror |
| 13 | Secondary convex mirror |
| 14 | Aperture |
| 15 | Light |
| 16 | Back reflector |
| 17 | Optical cavity |
| 18 | Resonator mirror |
| 19 | Substrate |
| 20 | Upper surface |
| 21 | Spacer layer |
| 22 | Sample |
| 23 | Piezo actuators |
| 24 | Window |
| 25 | Oil |
| 26 | Dielectric mirror |
| 27 | Spacer layer |
| 28 | Nanostructure |
| 29 | Protrusion |
| 30 | Upper surface |
| 31 | Biofunctionalization structure |
| 32 | Marker |
| 33 | Converging lens |

What is claimed is:

1. A mirror lens comprising a housing with a light passage opening, wherein at least one of a reflective or refractive optical element is arranged in the housing, wherein the mirror lens comprises a dielectric back reflector or a curved dielectric mirror is arranged in the light passage opening.

2. The mirror lens according to claim 1, wherein the optical element comprises a primary concave mirror and a secondary convex mirror, wherein the primary mirror has a central aperture, wherein the primary mirror and the secondary mirror are at least one of dielectric mirrors or wherein the optical element comprises at least one lens, comprising a converging lens.

3. The mirror lens according to claim 2, wherein the secondary mirror is arranged and configured to at least one of reflect light entering through the aperture toward the primary mirror or to reflect light reflected by the primary mirror out through the aperture.

4. The mirror lens according to claim 2, wherein the back reflector is arranged and configured to reflect light exiting through the aperture back through the aperture.

5. The mirror lens according to claim 2, wherein the primary mirror is a spherical or an aspherical mirror, the secondary mirror is a spherical or an aspherical mirror, and the primary mirror and the secondary mirror have a common center of curvature.

6. The mirror lens according to claim 2, wherein at least one of the primary mirror and the secondary mirror or the lens or the back reflector or the light passage opening or the curved mirror are arranged concentrically, wherein the secondary mirror is arranged between the primary mirror and the light passage opening, and wherein the primary mirror is arranged between the secondary mirror and the back reflector.

7. The mirror lens according to claim 1, wherein the back reflector is a curved, concave, mirror.

8. The mirror lens according to claim 1, further comprising actuators, wherein a position of the back reflector or the curved mirror can be varied by the actuators, wherein the actuators are piezo actuators.

9. An optical resonator device for performing optical absorption measurements, comprising a mirror lens according to claim 1.

10. The optical resonator device according to claim 9 comprising a flat, resonator mirror, wherein the optical resonator device comprises an optical cavity, wherein the optical cavity is formed between the resonator mirror and the back reflector or between the resonator mirror and the curved mirror.

11. The optical resonator device according to claim 10, wherein the optical resonator device comprises a substrate, wherein the substrate comprises the resonator mirror and at least one spacer layer, wherein the at least one spacer layer is arranged on an upper surface of the resonator mirror, wherein a sample can be arranged on the spacer layer, wherein the substrate comprises at least one of plasmonic or dielectric, nanostructures or biofunctionalization structures, wherein at least one of the nanostructures and biofunctionalization structures are provided in or on the at least one spacer layer.

12. The optical resonator device according to claim 10, further comprising actuators, wherein a position of the resonator mirror can be varied by the actuators, wherein the actuators are piezo actuators.

13. A method for optical absorption measurement in samples with a small absorption cross-section, wherein a sample is arranged in an optical resonator device according to claim 9.
